(19) United States
(12) Patent Application Publication
(10) Pub. No.: US 2025/0135333 A1
(43) Pub. Date: May 1, 2025

(54) VIRTUAL REALITY (VR) SYSTEM AND METHOD FOR SIMULATING A GAME AND PROVIDING ENHANCED IMMERSIVE EXPERIENCE

(71) Applicant: GOLF SCOPE INC d/b/a GOLD+, Austin, TX (US)

(72) Inventor: Ryan Engle, Austin, TX (US)

(21) Appl. No.: 18/927,720

(22) Filed: Oct. 25, 2024

Related U.S. Application Data
(60) Provisional application No. 63/546,295, filed on Oct. 30, 2023.

(51) Int. Cl. A63F 13/26

(52) U.S. Cl. CPC A63F 13/26; A63F 2300/8082

(57) ABSTRACT

A Virtual Reality (VR) golf simulator system for simulating the game of golf including a simulator, a VR headset and a server. The VR headset includes pass-through cameras that allow the user to view real-world objects while immersed in the VR environment. The simulator receives an alignment stick at its front and the VR headset aligns with the alignment stick. The simulator recognizes the presence of a golf ball and sends a signal to the server, which then transmits the signal to the VR headset to show a complete pass-through view of the real world. When a user hits a golf ball, the launch data is transmitted to the server from the simulator. The server forwards the data to the VR headset. The VR headset uses the data to generate a real-time simulation of the golf ball's trajectory in VR, which the user can observe from a traditional viewpoint.

### CROSS-REFERENCE TO RELATED APPLICATIONS

The present application claims the benefit of provisional Application No. 63/546,295, filed Oct. 30, 2023; all which is incorporated herein in its entirety and referenced thereto.

### BACKGROUND OF THE INVENTION

### Field of the Invention

The present invention relates to virtual reality (VR) systems. More specifically, the present invention relates to a Virtual Reality (VR) simulator system designed to enhance the user experience in training or playing a game such as golf by offering a more immersive and accurate simulation of the golf ball's trajectory.

### Description of the Prior Art

Many people enjoy playing golf as a game on a golf course. The game of golf is a club and a ball sport in which players use various clubs to hit a golf ball into a series of holes on the golf course in several strokes. Typically, the golf course requires a significant amount of investment and players have to spend a lot of money to play the game. With improvements in technology, golf simulators have been used by the players. The golf simulator allows the players to play golf on a graphically simulated golf course in an indoor setting. Typical golf simulators include a projector, a hitting screen and other equipment simulating the golf course and projecting a trajectory of the golf ball after being hit into the hitting screen, with the club.

Several golf simulators and other systems for playing golf in an indoor setting have been disclosed in the past. One such example is disclosed in a United States Publication No. 20220339534, entitled “Visual and tactile AR medium based on augmented reality” (“the '534 Publication”). The '534 Publication discloses a visual and tactile AR medium based on augmented reality for providing a user with visual and tactile information matched with the augmented reality when the user experiences the augmented reality through the AR medium capable of being connected to a part of a body of the user, the AR medium including: a tactile augmentation member configured to enable the part of the body of the user to feel the augmented reality in a tactile manner; a visual augmentation member configured to overlay a graphic on the AR medium, and being capable of performing visual change; and a control member configured to perform transmission and reception with the AR medium, wherein the control member is configured to control output of the tactile augmentation member or the visual augmentation member, corresponding to input from the user or the AR medium or both.

Another example is disclosed in a United States Publication No. 20230086248, entitled “Visual navigation elements for artificial reality environments” (“the '248 Publication”). The '248 Publication discloses systems, methods, and machine-readable media for providing and activating a link to artificial reality content in a shared artificial reality environment. Various aspects may include receiving a request to generate a visual navigation element for an artificial reality application configured to operate in the shared artificial reality environment, such as via a user representation. Aspects may include generating the visual navigation element and generating an audio element indicative of another user representation engaged in the artificial reality application for the user representation. Aspects may also include receiving an indication of activation of the visual navigation element and loading the artificial reality application for the user representation upon activation and while providing the audio element. Aspects may also include providing instructions to display the user representation in the artificial reality application upon completion of the loading.

Another example is disclosed in a United States Publication No. 20210379445, entitled “Golf ball placement system and a method of operating the same” (“the '445 Publication”). The '445 Publication discloses a golf system that includes a computing device associated with a user at a playing surface having at least one landmark object. The computing device includes a processor and a memory coupled to the processor. The memory may store processor-executable instructions that, when executed, configure the processor to: obtain topography data associated with a virtual golf hole for a virtual golf ball; determine a target destination location for the virtual golf ball on the playing surface based on the topography data and an anticipated virtual golf ball trajectory; and generating signals for communicating the target destination location and a ball placement location on the playing surface.

Although the above discussed disclosures are useful, they have few problems. For instance, traditional golf simulators use the projector to display the golf course simulation on a flat screen, creating a disconnect between the ball and the screen. This makes it difficult for the user to accurately judge distances and slopes. Further, the traditional golf simulators have challenges in simulating the experience of chipping and putting accurately.

Therefore, there is a need in the art to provide an improved Virtual Reality (VR) golf simulator system capable of providing a one-to-one visual representation in the VR environment making it easier for the user to judge distances and comprehend the topography of the golf course.

### SUMMARY OF THE INVENTION

It is an object of the present invention to provide a Virtual Reality (VR) golf simulator system that avoids the drawbacks of known golf simulators.

It is another object of the present invention to provide an improved Virtual Reality (VR) golf simulator system capable of providing a one-to-one visual representation in the VR environment making it easier for the user to judge distances and comprehend the topography of the golf course.

It is another object of the present invention to provide a Virtual Reality (VR) golf simulator system that provides an enhanced experience of chipping and putting in a VR environment.

In order to overcome one or more objects, the present invention presents a Virtual Reality (VR) golf simulator system having a simulator, a VR headset and a server. The golf simulator calculates various parameters associated with a golf ball's trajectory including, but not limited to, ball speed, vertical launch angle, horizontal launch angle, and spin. The VR headset includes pass-through cameras that allow the user to view real-world objects while immersed in the VR environment. The server facilitates real-time data transfer between the simulator and the VR headset. In operation, an alignment stick is positioned in front of the simulator. The simulator uses the alignment stick as a reference for determining the direction of a straight shot. Further, the VR headset is aligned with the alignment stick, ensuring that the VR headset and the simulator have consistent 3D alignment. When a golf ball enters the field of view of the simulator, a signal is transmitted to the server. The server further transmits the signal to the VR headset. The VR headset receives the signal and shows a complete pass-through view of the real world.

When a user hits the golf ball, the launch data including, but not limited to, ball speed, vertical launch angle, horizontal launch angle, and spin is transmitted to the server from the simulator. The server forwards the data to the VR headset. The VR headset uses the data to generate a real-time simulation of the golf ball's trajectory in VR, which the user can observe from a traditional viewpoint on the VR headset.

One advantageous feature of the present invention is that the VR golf simulator system can be used for short-range shots and putting. The golf simulator system presents an improved experience of chipping and putting by providing a more delicate touch, feel and precision in a virtual setting. This enhances the realism of short game practice.

Another advantageous feature of the present invention is that the VR golf simulator system provides a one-to-one visual representation in the VR environment, making it easier for the user to judge distances and comprehend the topography of the golf course. Further, the VR golf simulator system presents a VR environment that allows the user to change their viewing angle simply by moving their head, providing a more natural and immersive golfing experience.

The features and advantages of the invention here will become more apparent in light of the following detailed description of selected embodiments, as illustrated in the accompanying FIGURES. As will be realized, the invention disclosed is capable of modifications in various respects, all without departing from the scope of the invention. Accordingly, the drawings and the description are to be regarded as illustrative in nature.

### BRIEF DESCRIPTION OF THE DRAWINGS

FIG. 1 is an architectural diagram of a Virtual Reality (VR) system, in accordance with one embodiment of the present invention.

FIG. 2 is an environment in which a user wears a VR headset over his/her head and trains/plays the game of golf, in accordance with one embodiment of the present invention.

FIG. 3 is a block diagram of the VR headset, in accordance with one embodiment of the present invention.

FIG. 4 is a diagrammatic representation of a server, in accordance with one embodiment of the present invention.

FIG. 5, FIG. 6 and FIG. 7 illustrate a virtual environment displayed over a first display of the VR headset during the play, in accordance with one exemplary embodiment of the present invention.

FIG. 8 is a method for enhancing the user experience in golf training by offering a more immersive and accurate simulation of the golf ball's trajectory, in accordance with one embodiment of the present invention.

### DETAILED DESCRIPTION OF THE PREFERRED EMBODIMENT

The following detailed description set forth below in connection with the appended drawings is intended as a description of exemplary embodiments in which the presently disclosed invention may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed Virtual Reality (VR) golf simulator system. However, it will be apparent to those skilled in the art that the presently disclosed invention may be practiced without these specific details. In some instances, well-known structures and devices are shown in functional or conceptual diagram form in order to avoid obscuring the concepts of the presently disclosed VR system.

In the present specification, an embodiment showing a singular component should not be considered limiting. Rather, the invention preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known components referred to herein by way of illustration.

Although the present invention provides a description of a VR system, it is to be further understood that numerous changes may arise in the details of the embodiments of the VR system. It is contemplated that all such changes and additional embodiments are within the spirit and true scope of this disclosure.

The following detailed description is merely exemplary in nature and is not intended to limit the described embodiments or the application and uses of the described embodiments. All of the implementations described below are exemplary implementations provided to enable persons skilled in the art to make or use the embodiments of the disclosure and are not intended to limit the scope of the disclosure.

The present invention discloses a Virtual Reality (VR) golf simulator system for simulating the game of golf. The VR system includes a simulator, a VR headset (with two controllers) and a server. The VR headset includes pass-through cameras that allow the user to view real-world objects while immersed in the VR environment. The VR headset uses pass-through cameras to identify the placement of an alignment stick at the front. Further, the VR headset calibrates the position of the alignment stick. In other words, an alignment stick is placed in front of the simulator. Here, the simulator uses the alignment stick as a reference for determining the direction of a straight shot. The simulator recognizes the presence of a golf ball and sends a signal to the server, which then transmits the signal to the VR headset to show a complete pass-through view of the real world. When a user hits the golf ball, the launch data is transmitted to the server from the simulator. The server forwards the data to the VR headset. The VR headset uses the data to generate a real-time simulation of the golf ball's trajectory in VR, which the user can observe from a traditional viewpoint.

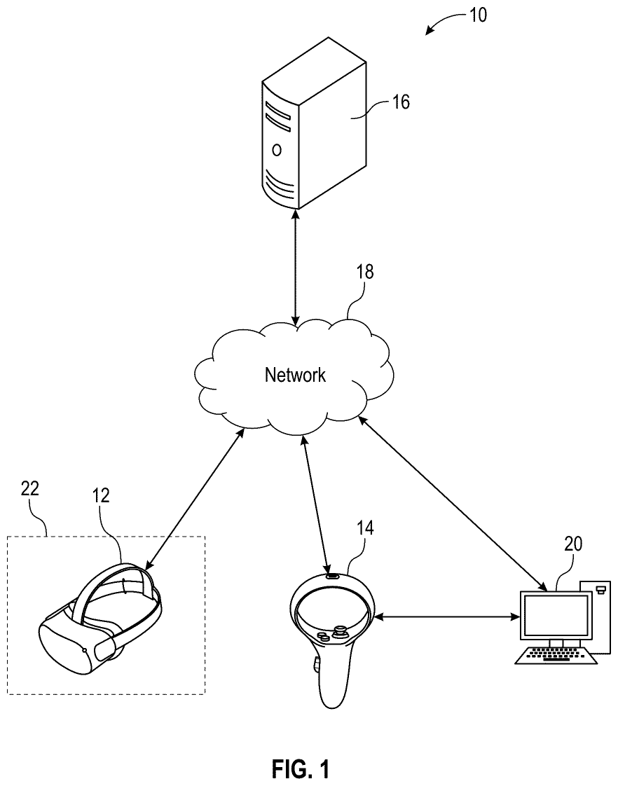

Various features and embodiments of a Virtual Reality (VR) system for simulating a game of golf and enhancing the user experience in golf training and/or playing are explained in conjunction with the description of FIGUREs (FIGS. 1-8).

FIG. 1 shows an architectural diagram of a Virtual Reality (VR) system 10 for simulating a game of golf and enhancing the user experience in golf training and/or playing, in accordance with one embodiment of the present invention. VR system 10 and system 10 are interchangeably used in the following specification and mean that the system implements simulation of golf over virtual reality (VR) headset. System 10 includes a virtual reality (VR) headset or mixed reality headset or augmented reality headset or VR glasses 12. System 10 further includes a real life golf club 14. In one example, virtual reality headset 12 communicatively connects to a server 16 via a network 18. In one example, system 10 includes an electronic device or simulator 20 communicatively connecting server 16. In one embodiment, server 16 obtains data from each of virtual reality headset 12, handheld interactive tool or golf club 14 and simulator 20 and presents the processed information at virtual reality headset 12.

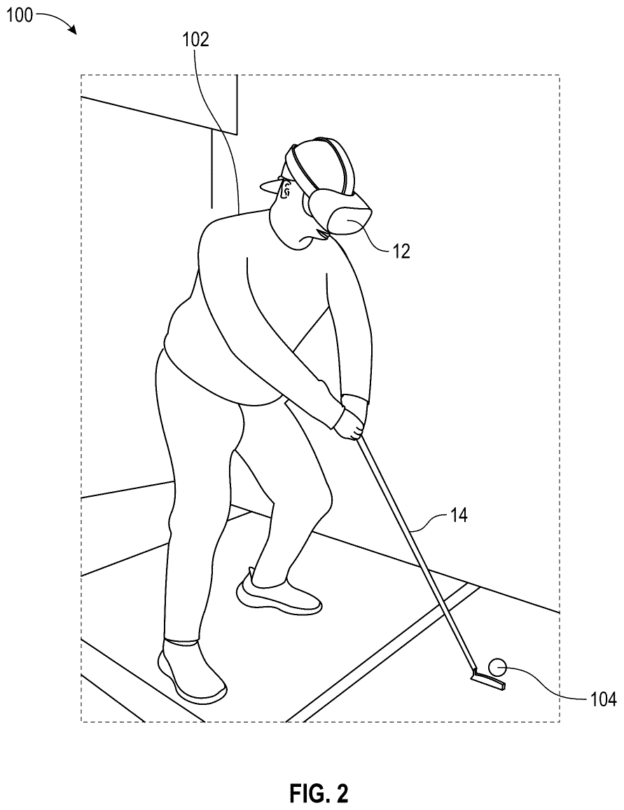

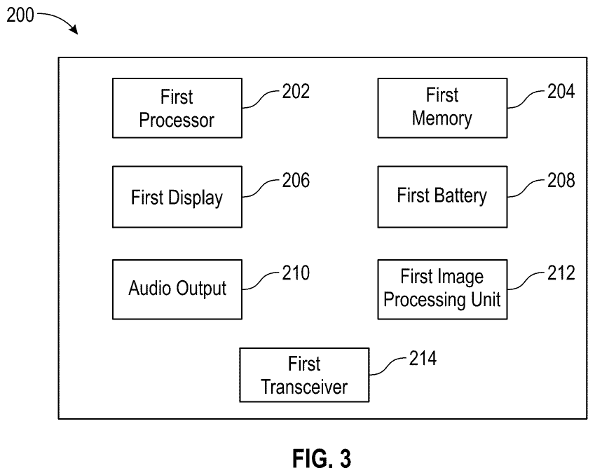

FIG. 2 shows an environment 100 in which a user 102 wears VR headset 12 over his/her head and trains/plays the game of golf. As can be seen, user 102 wears VR headset 12 and holds golf club 14 in his/her hands for simulating playing of golf game with the help of a golf ball 104 being hit towards hitting area 22. FIG. 3 shows a block diagram of virtual reality headset 12, in accordance with one embodiment of the present invention. Virtual reality headset 12 includes a first processor 202, a first memory 204, a first display 206, a first battery 208, an audio output or a speaker 210, a first image processing unit 212 and a first transceiver 214.

First processor 202 includes a central processing unit (CPU), a graphics processing unit (GPU) or both. First memory 204 includes a volatile memory and/or a non-volatile memory. Preferably, first memory 204 stores instructions or software programs that interact with the other devices. In one implementation, first processor 202 executes the program instructions stored in first memory 204 in any suitable manner. First display 206 includes a liquid crystal display (LCD) or Light Emitting Diode (LED) display positioned to face the eyes of user 102 when he/she puts on virtual reality headset 12. First battery 208 indicates a rechargeable battery such as Lithium-Ion battery for powering virtual reality headset 12. Optionally, virtual reality headset 12 is powered by a power supply including, but not limited to, an auxiliary power storage device, power banks, etc. Audio output 210 includes a speaker capable of announcing audio instructions to user 102. First image processing unit 212 indicates one or more cameras provided opposite end of first display 206 i.e., facing ahead of the user's head. First image processing unit 212 captures a field of view (real environment) ahead of user 102 and displays over first display 206. In accordance with the present invention, virtual reality headset 12 includes first image processing unit 212 acting as a pass-through camera in order to allow user 102 to view real-world objects while being immersed in the VR environment. Optionally, first display 206 allows user 102 to see through a portion of area such that user 102 is able to view the real environment in front of his/her while also having the ability to view the VR environment. First transceiver 214 transmits or receives the instructions over network 18 utilizing any one of a number of well-known transfer protocols.

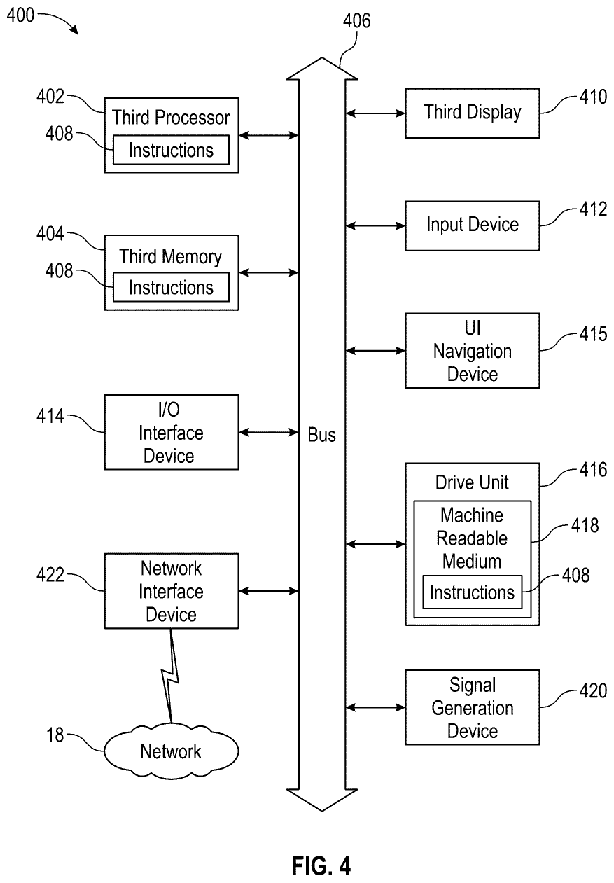

FIG. 4 shows a diagrammatic representation of server 16, in accordance with one embodiment of the present invention. Server 16 encompasses a third processor 402 (e.g., a central processing unit (CPU), a graphics processing unit (GPU) or both). Third processor 402 electrically couples to a third memory 404 via a data bus 406. Third memory 404 includes a volatile memory and/or a non-volatile memory. Preferably, third memory 404 stores instructions or software program 408 that interact with the other devices in virtual reality headset 12, golf club 14 and/or simulator 20. In one implementation, third processor 402 executes instructions 408 stored in third memory 404 in any suitable manner. In one implementation, third memory 404 stores digital data indicative of documents, files, programs, etc., retrieved from one of virtual reality headset 12, golf club 14 and/or simulator 20.

Server 16 further includes a third display 410 (e.g., a liquid crystal display (LCD) or a cathode ray tube (CRT)). Server 16 includes an input device (e.g., a keyboard) and/or a touchscreen 412, Input/output (I/O) interface device 414, a user interface (UI) navigation device 415 (e.g., a mouse), a drive unit 416, a signal generation device 420 (e.g., a speaker) and a network interface device 422.

Drive unit 416 includes a machine-readable medium 418 on which one or more sets of instructions and data structures (e.g., software 408) is stored. It should be understood that the term “machine-readable medium” includes a single medium or multiple medium (e.g., a centralized or distributed database, and/or associated caches and servers) that stores one or more sets of instructions. The term “machine-readable medium” also includes any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” accordingly includes, but not limited to, solid-state memories, optical and magnetic media, and carrier wave signals.

Instructions 408 reside, completely or at least partially, within third memory 404 and/or within third processor 402 during execution thereof by server 402. Network interface device 422 transmits or receives instructions 408 over network 18 utilizing any one of a number of well-known transfer protocols.

Network 18 includes a wireless network, a wired network or a combination thereof. Network 18 can be implemented as one of the different types of networks, such as intranet, local area network (LAN), wide area network (WAN), the internet, and the like. Network 18 implements as a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 18 includes a variety of network devices, including routers, bridges, servers, computing devices, storage devices, and the like.

Simulator 20 communicatively connects to golf club 14. Simulator 20 is configured to calculate various parameters associated with a trajectory of a golf ball 104 trajectory, including but not limited to ball speed, vertical launch angle, horizontal launch angle, and spin. In accordance with the present invention, an alignment stick (not shown) is placed in front of simulator 20 as a reference for determining the direction of a shot. Here, the alignment stick is placed in front of simulator 20. Further, simulator 20 uses the alignment stick as a reference for determining the direction of a straight shot. Further, VR headset 12 with the help of first image processing unit 212 aligns with the alignment stick ensuring that VR headset 12 and simulator 20 have consistent three-dimensional (3D) alignment.

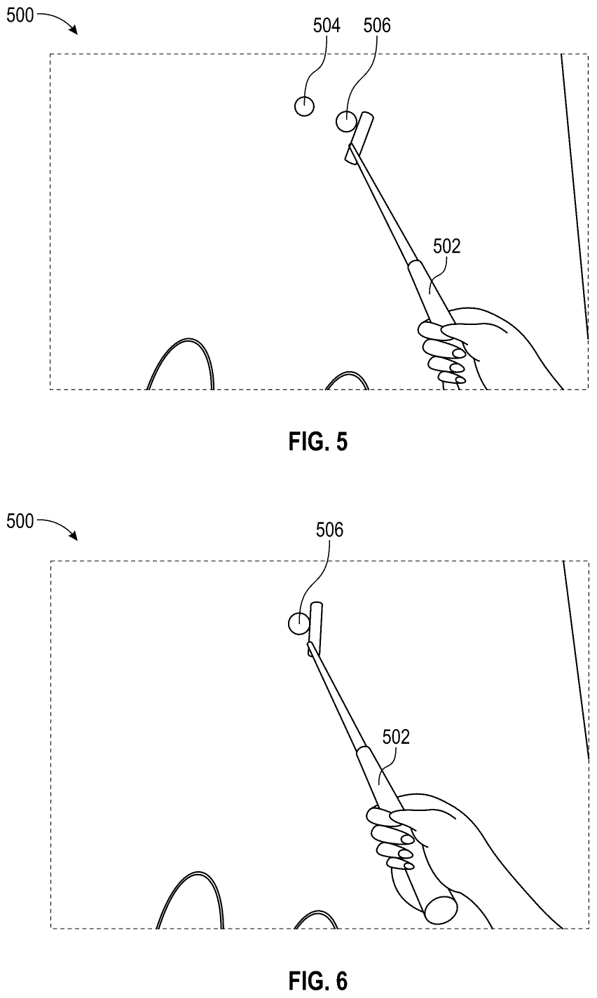

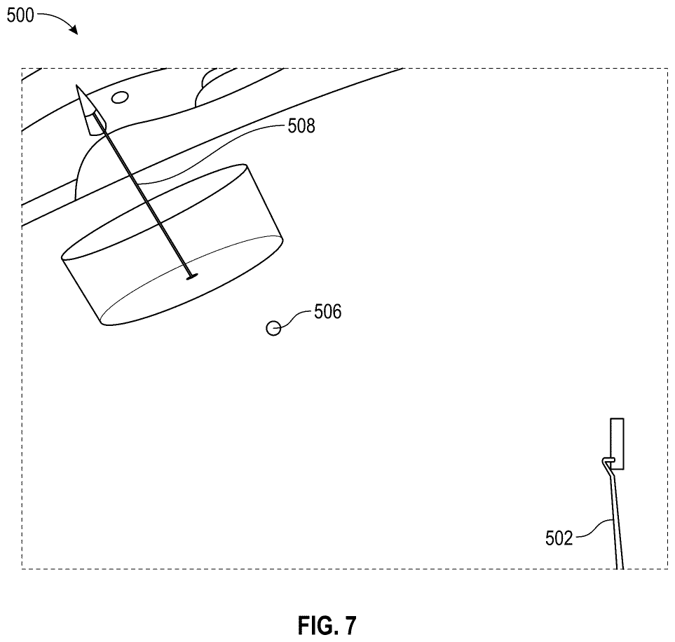

When a golf ball enters the field of view of simulator 20, a signal is transmitted to server 16. Subsequently, server 16 forwards the signal to VR headset 12. VR headset 12 receives the signal and shows a complete pass-through view of the real world. Further, when user 102 hits the golf ball, data corresponding to the launch of the ball, ball speed, vertical launch angle, horizontal launch angle, and spin is transmitted to server 20. Further, server 16 transmits the data to VR headset 12. VR headset 12 uses the data to generate a real-time simulation of the golf ball's trajectory, which user 102 can observe from a traditional viewpoint on first display 206 of VR headset 12. Now, referring to FIG. 5, FIG. 6 and FIG. 7, an exemplary embodiment of playing golf is explained. FIG. 5 shows a virtual environment 500 displayed over first display 206 of VR headset 12. Here, virtual environment 500 displays a virtual club 502. Virtual club 502 mimics the position of golf club 14. In other words, virtual club 502 hovers or moves with respect to the position of golf club 14 in the user's hand. First image processing unit 212 captures the position of golf ball 504 in the real environment. Further, VR headset 12 displays a virtual ball 506, as shown in FIG. 5. Here, user 102 adjusts position of golf club 14 such that virtual club 502 positions virtual ball 506 over real golf ball 504, as shown in FIG. 6. Subsequently, user 102 swings golf club 14 mimicking hitting the virtual golf ball 506, while actually hitting the real golf ball 504. Here, simulator 20 detects the angle at which golf club 14 is swung and determines golf ball trajectory, including but not limited to ball speed, vertical launch angle, horizontal launch angle, and spin. FIG. 7 shows an exemplary scenario in which virtual ball 506 is travelling towards a post 508. As specified above, simulator 20 transmits a signal to server 16, which in turn forwards the signal to VR headset 12. Here, after user 102 hitting the ball 104, VR headset 12 receives the signal and shows the ball trajectory, and flight of the ball in the VR environment on first display 206, as shown in FIG. 7, for example.

In accordance with the present invention, VR headset 12 provides a one-to-one visual representation in the VR environment, making it easier for user 102 to judge distances and comprehend the topography of the golf course. This helps in putting, as user 102 can intuitively understand how far the hole is and can more easily perceive the contours of the green or surrounding area. Further, the VR environment allows user 102 to change their viewing angle simply by moving their head, providing a more natural and immersive golfing experience.

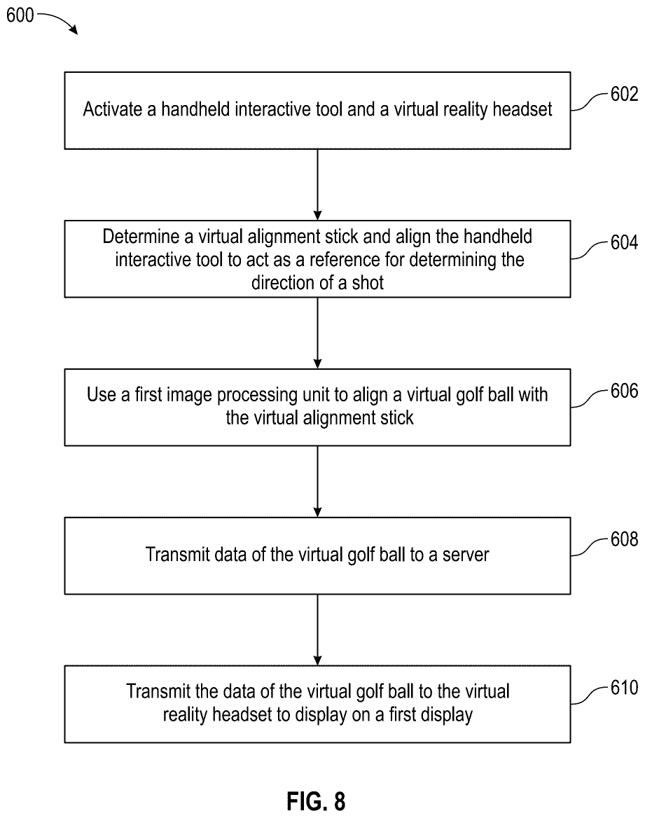

FIG. 8 illustrates a method 600 for enhancing the user experience in golf training by offering a more immersive and accurate simulation of the golf ball's trajectory, in accordance with one exemplary embodiment of the present invention. The order in which method 600 is described should not be construed as a limitation, and any number of the described method blocks can be combined in any order to implement method 600 or alternate methods. Additionally, individual blocks may be deleted from method 600 without departing from the spirit and scope of the invention described herein. Furthermore, method 600 can be implemented in any suitable hardware, software, firmware, or combination thereof. However, for ease of explanation, in the embodiments described below, method 600 may be implemented using the above-described system 10.

Method 600 starts at step 602. At step 602, VR headset 12 and golf club 14 are activated. At step 604, an alignment stick is placed in front of simulator 20. Here, simulator 20 uses the alignment stick as a reference for determining the direction of a straight shot. At step 606, VR headset 12 uses pass-through cameras (first image processing unit 206), and aligns with the alignment stick, ensuring that VR headset 12 and simulator 20 have consistent 3D alignment.

At step 608, when a golf ball enters the field of view of simulator 20, a signal is transmitted to server 16, which then forwards the signal to VR headset 12. At step 610, VR headset 12 receives the signal and shows a complete pass-through view of the real world on first display 106 of VR headset 12. Here, VR headset 12 uses the data to generate a real-time simulation of the golf ball's trajectory and displays on first display 106.

The presently disclosed system provides several advantages over prior art. The VR system provides a one-to-one visual representation in the VR environment, making it easier for the user to judge distances and comprehend the topography of the golf course. Further, the VR system helps to train for short-range shots and putting.

The present invention has been described in particular detail with respect to various possible embodiments, and those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of the above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, should be understood as being implemented by computer programs.

Further, certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art along with equivalent variations. In addition, the present invention is not described with reference to any particular programming language. It is appreciated that a variety of programming languages may be used to implement the teachings of the present invention as described herein, and any references to specific languages are provided for disclosure of enablement and best mode of the present invention.

It should be understood that components shown in FIGUREs are provided for illustrative purposes only and should not be construed in a limited sense. A person skilled in the art will appreciate alternate components that may be used to implement the embodiments of the present invention and such implementations will be within the scope of the present invention.

While preferred embodiments have been described above and illustrated in the accompanying drawings, it will be evident to those skilled in the art that modifications may be made without departing from this invention. Such modifications are considered as possible variants included in the scope of the invention.

What is claimed is:

1. A Virtual Reality (VR) simulator system for simulating a golf game, said VR simulator system comprising:
a Virtual Reality (VR) headset comprising a display; and
a simulator communicatively connected to said VR headset,
wherein said simulator captures the position of a golf club and a golf ball in its field of view,
wherein said simulator creates a virtual club corresponding to said golf club and a virtual ball corresponding to said golf ball,
wherein said simulator simulates a swing of said virtual club and a trajectory of said virtual ball corresponding to the swing of said golf club hitting said golf ball, and
wherein said simulator transmits the simulated swing of said virtual club and the trajectory of said virtual ball to said VR headset for displaying in a VR environment over said display in real-time.

2. The VR simulator system of claim 1, wherein said trajectory of said virtual ball comprises one of ball speed, vertical launch angle, horizontal launch angle, and spin.

3. The VR simulator system of claim 2, wherein said VR headset displays the trajectory and a flight of said virtual ball in the VR environment on said display.

4. The VR simulator system of claim 1, wherein said simulator comprises an alignment stick placed in front of said simulator for use as a reference for determining the direction of swing of said golf club hitting said golf ball.

5. The VR simulator system of claim 4, wherein said VR headset comprises an image processing unit for capturing a field of view ahead of a user wearing said VR headset.

6. The VR simulator system of claim 5, wherein said VR headset utilizes said image processing unit to align with said alignment stick in order to ensure said VR headset and said simulator have consistent three-dimensional (3D) alignment of said virtual club and virtual ball corresponding to said gold club and said golf ball.

7. The VR simulator system of claim 5, wherein said image processing unit acts as a pass-through camera to provide a real-world view alongside the VR environment on said display.

8. The VR simulator system of claim 1, further comprises a server communicatively connected to said simulator and said VR headset via a network, wherein said server receives a signal from said simulator and transmits to said VR headset.

9. The VR simulator system of claim 1, wherein said VR headset is configured to provide a one-to-one visual representation of a golf course in the VR environment on said display.

10. A method of simulating a golf game using a Virtual Reality (VR) simulator system, said method comprising the steps of:
providing a Virtual Reality (VR) headset having a display;
providing a simulator communicatively connected to said VR headset;
capturing, by said simulator, the position of a golf club and a golf ball in its field of view;
creating, by said simulator, a virtual club corresponding to said golf club and a virtual ball corresponding to said golf ball;
simulating, by said simulator, a swing of said virtual club and a trajectory of said virtual ball corresponding to the swing of said golf club hitting said golf ball; and
transmitting, by said simulator, the simulated swing of said virtual club and the trajectory of said virtual ball to said VR headset for displaying in a VR environment over said display in real-time.

11. The method of claim 10, further comprising simulating the trajectory comprising one of ball speed, vertical launch angle, horizontal launch angle, and spin of said virtual ball.

12. The method of claim 11, further comprising displaying the trajectory and a flight of said virtual ball in the VR environment on said display.

13. The method of claim 10, further comprising providing an alignment stick for placement in front of said simulator for use as a reference for determining the direction of swing of said golf club hitting said golf ball.

14. The method of claim 13, further comprising providing an image processing unit at said VR headset for capturing a field of view ahead of a user wearing said VR headset.

15. The method of claim 14, further comprising configuring said VR headset to align with said alignment stick for ensuring said VR headset and said simulator have consistent three-dimensional (3D) alignment of said virtual club and virtual ball corresponding to said gold club and said golf ball.

16. The method of claim 14, further comprising configuring said image processing unit to act as a pass-through camera for providing a real-world view alongside the VR environment on said display.

17. The method of claim 10, further comprising providing a server communicatively connected to said simulator and said VR headset via a network, said server receiving a signal from said simulator and transmitting to said VR headset.

18. The method of claim 10, further comprising configuring said VR headset for providing a one-to-one visual representation of a golf course in the VR environment on said display.

19. A non-transitory computer-readable storage medium comprising instructions stored thereon, which when executed by one or more processors, cause said one or more processors to perform operations for simulating a golf game, comprising:
capturing a position of a golf club and a golf ball in a field of view of a simulator;
creating a virtual club corresponding to said golf club and a virtual ball corresponding to said golf ball;
simulating a swing of said virtual club and a trajectory of said virtual ball corresponding to the swing of said golf club hitting said golf ball; and
transmitting the simulated swing of said virtual club and the trajectory of said virtual ball to a Virtual Reality (VR) headset for displaying in a VR environment in real-time.

20. The non-transitory computer-readable storage medium of claim 19, further comprising:
providing an alignment stick for placement in front of said simulator for use as a reference for determining the direction of swing of said golf club hitting said golf ball; and
configuring said VR headset to align with said alignment stick for ensuring said VR headset and said simulator have consistent three-dimensional (3D) alignment of said virtual club and virtual ball corresponding to said gold club and said golf ball.
